(19) United States
(12) Patent Application Publication
(10) Pub. No.: US 2025/0279473 A1
(43) Pub. Date: Sep. 4, 2025

(54) ELECTROLYTE FOR LITHIUM IRON PHOSPHATE BATTERY, AND LITHIUM IRON PHOSPHATE BATTERY

(71) Applicants: GUANGZHOU TINCI MATERIALS TECHNOLOGY CO., LTD., Guangzhou (CN); JIUJIANG TINCI MATERIALS TECHNOLOGY CO., LTD., Jiujiang (CN)

(72) Inventors: Weizhen FAN, Guangzhou (CN); Chaojun FAN, Guangzhou (CN); Youting DING, Guangzhou (CN); Litao SHI, Guangzhou (CN); Jingwei ZHAO, Guangzhou (CN)

(73) Assignees: GUANGZHOU TINCI MATERIALS TECHNOLOGY CO., LTD., Guangzhou (CN); JIUJIANG TINCI MATERIALS TECHNOLOGY CO., LTD., Jiujiang (CN)

(21) Appl. No.: 19/200,264

(22) Filed: May 6, 2025

Related U.S. Application Data
(63) Continuation of application No. PCT/CN2023/126047, filed on Oct. 23, 2023.

(30) Foreign Application Priority Data
Nov. 18, 2022 (CN) 202211442144.3

(51) Int. Cl. H01M 10/0567; H01M 4/02; H01M 4/58; H01M 10/0525; H01M 10/0568; H01M 10/0569

(52) U.S. Cl. CPC H01M 10/0567; H01M 4/5825; H01M 10/0525; H01M 10/0568; H01M 10/0569; H01M 2004/028; H01M 2300/0037

(57) ABSTRACT

An electrolytic solution for a lithium iron phosphate battery, and a lithium iron phosphate battery. The electrolytic solution includes a solvent, a lithium salt, a first additive and a second additive.

### CROSS-REFERENCE TO RELATED APPLICATIONS

This application is a continuation of International Patent Application No. PCT/CN2023/126047, filed on Oct. 23, 2023, which claims the priority of the Chinese Patent Application No. 202211442144.3, titled “ELECTROLYTE FOR LITHIUM IRON PHOSPHATE BATTERY, AND LITHIUM IRON PHOSPHATE BATTERY”, filed with the China National Intellectual Property Administration on Nov. 18, 2022, each of which are incorporated herein by reference in their entireties.

### TECHNICAL FIELD

The present application relates to the field of lithium ion battery, in particular to an electrolytic solution for a lithium iron phosphate battery, and a lithium iron phosphate battery.

### BACKGROUND

With the decline of traditional energy sources, the development of lithium ion battery has been accelerating. Various countries have placed the advancement of energy storage battery and power battery at a national strategy level, providing significant funding and policy support. China has gone even further in this regard, shifting its focus from nickel-metal hydride battery to lithium iron phosphate battery. The phosphate-based positive electrode material of lithium iron phosphate battery offers exceptionally long cycle life, excellent safety performance, preferable high-temperature performance, extremely low price, and low-temperature performance and rate discharge capability comparable to lithium cobaltate battery, making it become the most promising material for power battery.

Chinese patent 202111199078.7 disclosed an electrolytic solution containing a phenyl sulfonate compound and a lithium ion battery. The electrolytic solution includes a first additive with the structure represented by Formula (I) and a second additive with an unsaturated bond.

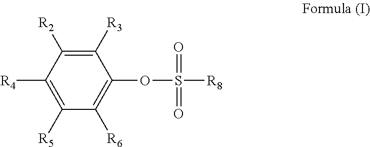

The first additive in this scheme can effectively inhibit the reduction of the impedance of the battery, particularly the low-temperature impedance, and further improve the high-temperature and low-temperature performance of the battery. The compound additive has an overall stable structure, and does not need to be stored at low temperature. The electrolytic solution using the compound additive also does not need to be stored at low temperature, and its stability is superior to that of the electrolytic solution containing ethylene sulfate (DTD). The electrochemical performance, particularly the cycle performance, of the battery under high voltage can be further enhanced by adopting the second additive containing unsaturated bonds in combination.

The prior art focused on the application of phenyl sulfonate compound in ternary positive electrode system. However, extensive researches have revealed that the performance improvement of this compound in ternary positive electrode system has reached its limit.

Compared to ternary battery, lithium iron phosphate battery offers advantages such as superior long-cycle performance, high safety performance, and low cost. However, it also has disadvantages such as low energy density and poor low-temperature performance, which restricts its application. Therefore, the technical problem addressed in the present application is as follows: how to expand the application scope of the aforementioned phenyl sulfonate compound, enabling it to achieve superior performance indexes in lithium iron phosphate positive electrode system than those in ternary positive electrode system.

### SUMMARY

The object of the present application is to provide an electrolytic solution for a lithium iron phosphate battery, and a lithium iron phosphate battery. The stability of the electrolytic solution is improved by adding a phenyl sulfonate compound and vinylene carbonate into the electrolytic solution. Meanwhile, it is surprised to find that the low-temperature cycle performance of the lithium iron phosphate battery is remarkably improved due to the combined use of the phenyl sulfonate compound and vinylene carbonate. In addition, the high-temperature cycle performance, the room-temperature cycle performance and the high-temperature storage performance of the lithium iron phosphate battery are significantly improved. In terms of the direct current internal resistance (DCIR) change rate, it is obviously superior to the ternary system.

To achieve the aforementioned object, the present application provides the following technical solutions:

In a first aspect, an electrolytic solution for a lithium iron phosphate battery is provided. The electrolytic solution includes a solvent, a lithium salt, a first additive and a second additive, the first additive has a general structural formula of Formula (I);

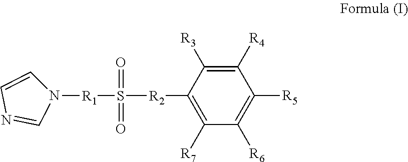

R₁ and R₂ are each independently selected from the group consisting of O, CH₂, and a carbon-carbon single bond, and at least one of R₁ and R₂ is O;
R₃, R₄, R₅, R₆, and R₇ are each independently selected from the group consisting of H, halogen, C₁₋₈ alkyl, C₂₋₈ alkenyl, C₃₋₈ alkynyl, halogen-substituted C₁₋₈ alkyl, halogen-substituted C₂₋₈ alkenyl, and halogen-substituted C₃₋₈ alkynyl; and
the second additive is vinylene carbonate.

Preferably, R₁ and R₂ are each independently selected from the group consisting of O and a carbon-carbon single bond; and
R₃, R₄, R₅, R₆, and R₇ are each independently selected from the group consisting of H, F, C₁₋₆ alkyl, C₂₋₆ alkenyl, C₃₋₈ alkynyl, F-substituted C₁₋₆ alkyl, F-substituted C₂₋₆ alkenyl, and F-substituted C₃₋₆ alkynyl.

Preferably, R₂ is O; R₃, R₄, R₅, R₆, and R₇ are each independently selected from the group consisting of H, F, methyl, ethyl, 1-propyl, 2-propyl, 1-butyl, 2-methyl-1-propyl, 2-butyl, fluoromethyl, fluoroethyl, fluoro-1-propyl, fluoro-2-propyl, fluoro-1-butyl, fluoro-2-methyl-1-propyl, fluoro-2-butyl, vinyl, propenyl, butenyl, fluorovinyl, fluoropropenyl, fluorobutenyl, propynyl, butynyl, fluoropropynyl, and fluorobutynyl.

Preferably, the first additive is selected the group consisting of the following compounds:

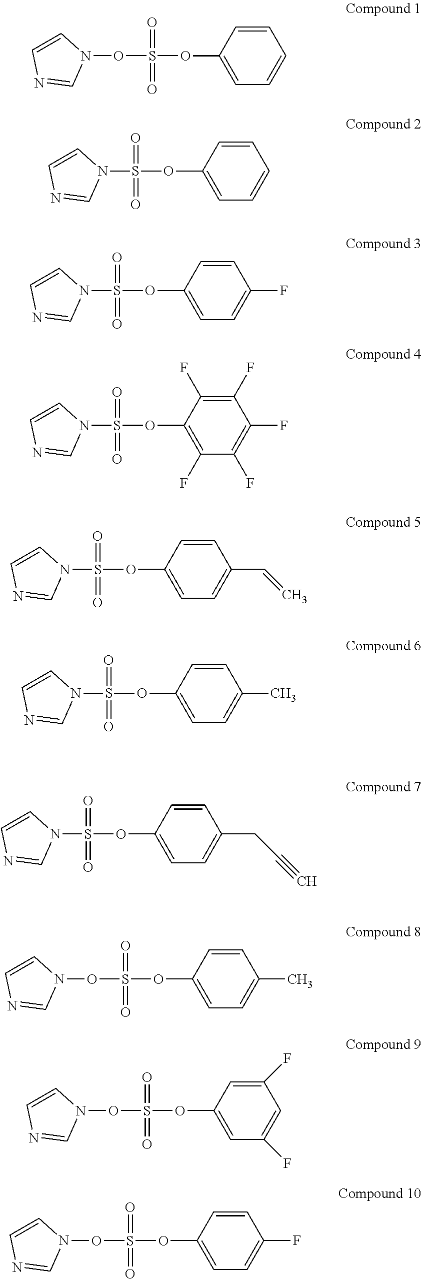

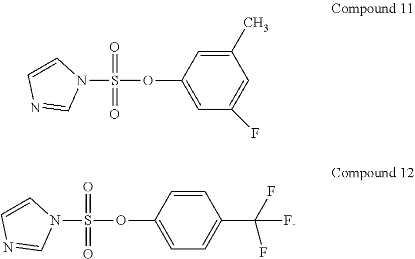 [SMILES: Cc1cc(F)cc(OS(=O)(=O)n2ccnc2)c1 ; O=S(=O)(Oc1ccc(C(F)(F)F)cc1)n1ccnc1]

Preferably, an adding amount of the first additive accounts for 0.01%-10% of a total mass of the electrolytic solution, and an adding amount of the second additive accounts for 0.1%-5% of the total mass of the electrolytic solution.

In an embodiment, the adding amount of the first additive accounts for 0.1%-5% of the total mass of the electrolytic solution, and the adding amount of the second additive accounts for 1%-5% of the total mass of the electrolytic solution.

It should be understood that the adding amount of the first additive includes, but is not limited to, 0.1%, 0.15%, 0.2%, 0.26%, 0.3%, 0.45%, 0.5%, 0.6%, 0.7%, 0.8%, 0.9%, 1%, 2%, 3%, 4%, and 5%, and the adding amount of the second additive includes, but is not limited to, 1%, 1.5%, 2%, 2.6%, 3%, 3.4%, 4%, 4.8%, and 5%.

In some embodiments of the present application, the lithium salt is selected from the group consisting of lithium hexafluorophosphate, lithium tetrafluoroborate, lithium bis(oxalato)borate, lithium difluoro(oxalato)borate, lithium difluoro(oxalato)phosphate, lithium tetrafluoro(oxalato)phosphate, lithium bis(fluorosulfonyl)imide, lithium bis(trifluoromethanesulfonyl)imide, and a combination thereof. When the lithium salt is selected from the group consisting of the above substances, a mass fraction of the lithium salt in the electrolytic solution is 5%-20%; preferably 7%-18%; more preferably 10%-15%.

In the actual production process, the optional amount of the above lithium salt includes, but is not limited to: 5%, 6%, 7%, 8%, 9%, 10%, 11%, 12%, 13%, 14%, 15%, 16%, 17%, 18%, 19%, 20%, and etc.

In other embodiments of the present application, the lithium salt can further be selected from the group consisting of lithium difluorophosphate, lithium monofluorophosphate, and a combination thereof. In view of the relatively low solubility of lithium difluorophosphate and lithium monofluorophosphate in ethyl methyl carbonate (EMC) solvent, when the lithium salt is selected from the group consisting of lithium difluorophosphate, lithium monofluorophosphate, and a combination thereof, the mass fraction of the lithium salt in the electrolytic solution is no more than 1%, preferably 0.01%-1%, and more preferably 0.02%-1%.

Preferably, the solvent includes a cyclic solvent and/or a linear solvent, and the cyclic solvent is selected from the group consisting of ethylene carbonate, propylene carbonate, γ-butyrolactone, phenyl acetate, 1,4-butane sultone, 3,3,3-trifluoropropylene carbonate, and a combination thereof;
the linear solvent is selected from the group consisting of dimethyl carbonate, ethyl methyl carbonate, diethyl carbonate, methyl propyl carbonate, methyl formate, ethyl acetate, methyl acetate, propyl acetate, butyl acetate, methyl propionate, ethyl propionate, propyl propionate, butyl propionate, methyl butyrate, ethyl butyrate, ethylene glycol dimethyl ether, 1,1,2,2-tetrafluoroethyl-2,2,3,3-tetrafluoropropyl ether, methyl 2,2,2-trifluoroethyl carbonate, bis(2,2,2-trifluoroethyl)carbonate, 2,2-difluoroethyl acetate, 2,2-difluoroethyl propionate, methyl 2,2-difluoroethyl carbonate, and a combination thereof.

In the electrolytic solution, a content of solvent is 65%-94.89% by mass percentage; preferably 70%-85% by mass percentage; more preferably 75%-85% by mass percentage.

In the actual production process, the optional amount of the solvent includes, but is not limited to: 65%, 70%, 75%, 80%, 85%, 90%, and etc.

Preferably, a third additive is further included, the third additive is selected from the group consisting of a sulfur-containing additive, a phosphorus-containing additive, a nitrogen-containing additive, an ester additive, and a combination thereof;
the sulfur-containing additive is selected from the group consisting of ethylene sulfate, 1,3-propanesultone, methylene methanedisulfonate, prop-1-ene-1,3-sultone, N-phenylbis(trifluoromethanesulfonyl)imide, 2,4,8,10-tetraoxa-3,9-dithiaspiro[5.5]undecane 3,3,9,9-tetraoxide, and a combination thereof;
the phosphorus-containing additive is selected from the group consisting of tris(trimethylsilyl) phosphate, tris[ethenyl(dimethyl)silyl] phosphate, tetramethyl methylenediphosphonate, and a combination thereof;
the nitrogen-containing additive is selected from the group consisting of prop-2-yn-1-yl 1H-imidazole-1-carboxylate, hexamethylene diisocyanate, prop-2-en-1-yl 1H-imidazole- 1-carboxylate, 2-fluoropyridine, and a combination thereof;
the ester additive is selected from the group consisting of vinyl ethylene carbonate, fluoroethylene carbonate, ethenyl 2,2,2-trifluoroethyl carbonate, and a combination thereof; and
an amount of the third additive is no more than 5% of a total amount of the electrolytic solution.

It should be understood that the third additive in the present application is an optional additive, and its amount in the electrolytic solution includes, but is not limited to: 0%, 0.1%, 0.15%, 0.2%, 0.26%, 0.3%, 0.45%, 0.5%, 0.6%, 0.7%, 0.8%, 0.9%, 1%, 2%, 3%, 4%, and 5%.

The electrolytic solution provided in the present application can be prepared by any suitable method known in the art, for example:
the electrolytic solution can be obtained by adding the lithium salt, the first additive, the second additive, and the third additive to the solvent in proportion and mixing.

In addition, the present application also discloses a lithium iron phosphate battery. The lithium iron phosphate battery includes:
a positive electrode plate;
a negative electrode plate;
a separator; and
the electrolytic solution described in the first aspect; where an active substance of the positive electrode plate is lithium iron phosphate.

The beneficial effects of the present application are as follows:

By using an electrolytic solution additive containing a compound with the structure of Formula (I) and vinylene carbonate, the low-temperature cycle performance can be significantly improved and the impedance of the battery can be reduced. In addition, the high-temperature cycle performance, the room-temperature cycle performance, the high-temperature storage performance, and the stability of the electrolytic solution are improved. The first additive compound exhibits excellent film forming property, which can form a solid electrolyte interface (SEI) film on the negative electrode by reduction during the initial charging process of the battery. The sulfur-rich SEI film is contributed to significantly improve ionic conductivity, reduce the impedance of the battery, and improve the cycle performance of the battery. After the introduction of sulfur element by a relatively sparse SEI film formed by the reduction of the first additive, the introduction of the second additive further forms a dense SEI film on this basis, avoiding the problem of gas production caused by the deterioration of imidazole group at high temperature, thus can effectively improve the low-temperature cycle performance, room-temperature cycle performance, high-temperature cycle performance, and high-temperature storage performance of the battery. The first additive contains nitrogen atom with lone electron pair, making the compound exhibit weak Lewis basicity in the electrolytic solution, which is allowed to form a hexa-coordinate complex with PF₅, reducing the Lewis acidity and reactivity of PF₅, thereby effectively inhibiting the increase in acidity of the electrolytic solution and suppressing the color increase caused by reaction between PF₅ and the trace impurity in the electrolytic solution, which further enhances the stability of the electrolytic solution.

It should be understood that the electrolytic solution of the present application is suitable for the lithium iron phosphate positive electrode system. Experimental results in the present application demonstrate that, compared to the ternary system, the low-temperature cycle performance of the above-mentioned electrolytic solution in a lithium iron phosphate system is remarkably improved. Simultaneously, its high-temperature and room-temperature cycle performance and the high-temperature storage performance are significantly improved.

### BRIEF DESCRIPTION OF THE DRAWINGS

FIG. 1 shows the SEM images of the battery negative electrodes of Comparative Example 5, Comparative Example 2, and Example 1;

FIG. 2 shows the dQ/dV curves of Comparative Example 5, Comparative Example 2, and Example 1;

FIG. 3 shows the AC impedance spectra after high-temperature storage for 14 days of Comparative Example 5, Comparative Example 2, and Example 1.

### DETAILED DESCRIPTION

The present application is described in more detail below in order to facilitate the understanding of the present application. However, it should be understood that the present application can be implemented in many different forms and is not limited to the embodiments or examples described herein. On the contrary, the purpose of providing these embodiments or examples is to enable a more thorough and comprehensive understanding of the disclosure of the present application.

Unless otherwise defined, all technical and scientific terms used herein have the same meanings as commonly understood by those skilled in the art of the present application. The terms used in the description of the present application are solely for the purpose of describing specific embodiments or examples and are not intended to limit the scope of the present application.

In the description of the present application, it should be noted that where the specific conditions are not indicated in the examples, conventional conditions or conditions recommended by the manufacturer are followed. Unless otherwise specified, where the manufacturers are not indicated, all reagents or instruments are commercially available conventional products.

### Preparation of the Lithium Iron Phosphate Battery

1. Preparation of the electrolytic solution: Solvents of ethylene carbonate and ethyl methyl carbonate were mixed in a mass ratio of 1:2. After mixing, LiPF₆ was added with an adding amount of LiPF₆ accounts for 13% of the weight of the electrolytic solution. Once the lithium salt was completely dissolved, the first additive and second additive were added.
2. Preparation of the positive electrode plate: Positive electrode material lithium iron phosphate, conductive agent SuperP, binder polyvinylidene difluoride (PVDF), and carbon nanotubes (CNTs) were mixed in a mass ratio of 95.8:1:2.5:0.7 (N-methylpyrrolidone (NMP) was used as the solvent) to generate a lithium ion battery positive electrode slurry with a certain viscosity, which was coated on a carbon-coated aluminum foil current collector with a coating amount of 35 mg/cm². After dried at 85° C., cold pressing was performed. The resultant was then edge trimmed, cut, and slit. After slitting, the resultant was dried under vacuum condition at 85° C. for 4 hours, the tabs were weld, and the required lithium-ion battery positive electrode plate was prepared.
3. Preparation of the negative electrode plate: Graphite, conductive agent SuperP, thickener carboxyl methyl cellulose (CMC), and binder styrene-butadiene rubber emulsion (SBR) were mixed in a mass ratio of 95:1.5:1.5:2.0 to generate a slurry. The mixed slurry was coated on both sides of a copper foil. The resultant was dried, and rolled press to obtain the negative electrode plate, and the required lithium-ion battery negative electrode plate was prepared.
4. Preparation of the lithium-ion battery: The positive electrode plate and negative electrode plate prepared according to the above processes and separator were used to prepare a lithium-ion battery with a thickness of 5.0 mm, a width of 60 mm, and a length of 67 mm by a winding process. The battery was baked in vacuum at 85° C. for 48 hours and the above electrolytic solution was injected. After holding for 24 hours, the battery was charged with a constant current of 0.1 C (130 mA) to 3.4 V, aged for 24 hours, then charged to 3.65 V with a constant current of 0.2 C and a constant voltage, and discharged to 2 V with a constant current of 0.2 C. Subsequently, charging and discharging was repeated once with a current of 0.5 C and five times with a current of 1 C. Finally, the battery was charged to 3.65 V with a current of 1 C, and preparation of the battery was completed.

### Example 1

The first additive in this example is Compound 2 with the structural formula as follows,

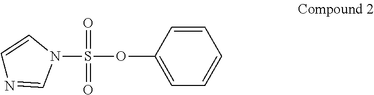 [SMILES: O=S(=O)(Oc1ccccc1)n1ccnc1]

vinylene carbonate (VC) was used as the second additive, where Compound 2 accounted for 0.1% of the weight of the electrolytic solution; VC accounted for 2.5% of the weight of the electrolytic solution; and
the lithium-ion battery was prepared according to the above preparation method for the lithium-ion battery.

### Example 2

Example 2 is essentially identical to Example 1, with the difference being that in this example, Compound 2 accounted for 1% of the weight of the electrolytic solution; and VC accounted for 2.5% of the weight of the electrolytic solution.

### Example 3

Example 3 is essentially identical to Example 1, with the difference being that in this example, Compound 2 accounted for 5% of the weight of the electrolytic solution; and VC accounted for 2.5% of the weight of the electrolytic solution.

### Example 4

Example 4 is essentially identical to Example 1, with the difference being that in this example, Compound 2 accounted for 1% of the weight of the electrolytic solution; and VC accounted for 0.1% of the weight of the electrolytic solution.

### Example 5

Example 5 is essentially identical to Example 1, with the difference being that in this example, Compound 2 accounted for 1% of the weight of the electrolytic solution; and VC accounted for 1% of the weight of the electrolytic solution.

### Example 6

Example 6 is essentially identical to Example 1, with the difference being that in this example, Compound 2 accounted for 1% of the weight of the electrolytic solution; and VC accounted for 5% of the weight of the electrolytic solution.

### Example 7

Example 7 is essentially identical to Example 2, with the difference being that Compound 6 was used as the first additive.

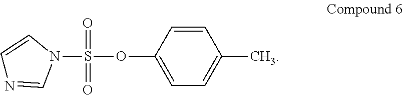 [SMILES: Cc1ccc(OS(=O)(=O)n2ccnc2)cc1]

### Example 8

Example 8 is essentially identical to Example 2, with the difference being that Compound 1 was used as the first additive.

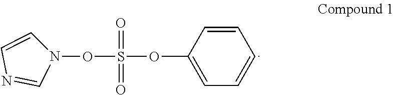 [SMILES: O=S(=O)(Oc1ccccc1)On1ccnc1 ; "."]

### Example 9

Example 9 is essentially identical to Example 1, with the difference being that LiPF₆ and lithium bis(fluorosulfonyl)imide (LiFSI) were selected as the lithium salts, and LiPF₆ and lithium bis(fluorosulfonyl)imide accounted for 12% and 1% of the weight of the electrolytic solution, respectively.

### Example 10

Example 10 is essentially identical to Example 1, with the difference being that ethylene carbonate (EC):ethyl methyl carbonate (EMC):diethyl carbonate (DEC)=3:5:2 was selected as the solvent.

### Example 11

Example 11 is essentially identical to Example 1, with the difference being that a third additive was further included, and fluoroethylene carbonate (FEC) was selected as the third additive, which accounted for 1% of the weight of the electrolytic solution.

### Example 12

Example 12 is essentially identical to Example 1, with the difference being that a third additive was further included, and tris(trimethylsilyl) phosphate (TMSP) was selected as the third additive, which accounted for 0.5% of the weight of the electrolytic solution.

### Comparative Example 1

Comparative Example 1 is generally identical to Example 1, with the difference being that the first additive and the second additive were not included in this comparative example.

### Comparative Example 2

Comparative Example 2 is generally identical to Example 1, with the difference being that only 0.1% of the first additive Compound 2 was included, and the second additive was not included in this comparative example.

### Comparative Example 3

Comparative Example 3 is generally identical to Example 1, with the difference being that only 1% of the first additive Compound 2 was included, and the second additive was not included in this comparative example.

### Comparative Example 4

Comparative Example 4 is generally identical to Example 1, with the difference being that the first additive was not included, and only 1% of VC was included in this comparative example.

### Comparative Example 5

Comparative Example 5 is generally identical to Example 1, with the difference being that the first additive was not included, and only 2.5% of VC was included in this comparative example.

### Comparative Example 6

Comparative Example 6 is generally identical to Example 1, with the difference being that the first additive was not included, and only 5% of VC was included in this comparative example.

### Comparative Example 7

Comparative Example 7 is generally identical to Example 1, with the difference being that 0.1% of Compound 2 was used as the first additive, and 2.5% of vinyl ethylene carbonate (VEC) was used as the second additive.

### Comparative Example 8

Comparative Example 8 is generally identical to Example 1, with the difference being that 0.1% of Compound I as follows was used as the first additive, and 2.5% of VC was used as the second additive.

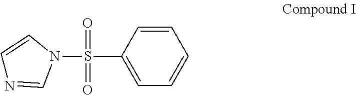 [SMILES: O=S(=O)(c1ccccc1)n1ccnc1]

### Comparative Example 9

Comparative Example 9 is generally identical to Example 1, with the difference being that 0.5% of lithium difluorophosphate was used as the first additive, and 2.5% of VC was used as the second additive.

### Comparative Example 10

Comparative Example 10 is generally identical to Example 1, with the difference being that 1% of phenyl methanesulfonate was used as the first additive, and 2.5% of VC was used as the second additive.

### Comparative Example 11

Comparative Example 11 is generally identical to Example 1, with the difference being that 1% of Compound II as follows was used as the first additive, and 2.5% of VC was used as the second additive.

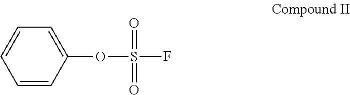 [SMILES: O=S(=O)(F)Oc1ccccc1]

### Comparative Example 12

Comparative Example 12 is generally identical to Example 1, with the difference being that 1% of Compound III as follows was used as the first additive, and 2.5% of VC was used as the second additive.

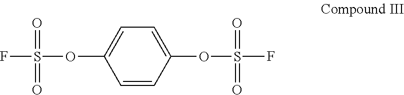 [SMILES: O=S(=O)(F)Oc1ccc(OS(=O)(=O)F)cc1]

### Comparative Example 13

Comparative Example 13 is generally identical to Example 1, with the difference being that 0.1% of Compound 2 was used as the first additive, and 2.5% of prop-1-ene-1,3-sultone was used as the second additive.

### Comparative Example 14

Comparative Example 14 is generally identical to Example 1, with the difference being that LiNi_{0.8}Co_{0.1}Mn_{0.1}O₂ was used as the positive electrode material, and the electrolytic solution didn't include any additive.

### Comparative Example 15

Comparative Example 15 is generally identical to Example 1, with the difference being that LiNi_{0.8}CO_{0.1}Mn_{0.1}O₂ was used as the positive electrode material.

### Comparative Example 16

Comparative Example 16 is generally identical to Example 1, with the difference being that LiNi_{0.8}Co_{0.1}Mn_{0.1}O₂ was used as the positive electrode material, and the electrolytic solution only included 2.5% of VC and did not include the first additive.

### Battery Performance Test

High-temperature storage: After formation and capacity grading, the lithium iron phosphate battery was placed in a thermostatic tank at 60° C. and stored for 14 days. The battery was discharged at a constant current of 1 C to 2.0 V, and then charged at a constant current of 1 C and a constant voltage to 3.65 V. The capacity retention rate and recovery rate were tested. Thickness of the battery was measured before and after storage, and the thickness expansion rate after high-temperature storage for 14 days was calculated.

After formation and capacity grading, the ternary battery was placed in a thermostatic tank at 60° C. and stored for 14 days. The battery was discharged at a constant current of 1 C to 3.0 V, and then charged at a constant current of 1 C and a constant voltage to 4.2 V. The capacity retention rate and recovery rate were tested. Thickness of the battery was measured before and after storage, and the thickness expansion rate after high-temperature storage for 14 days was calculated.

DCIR performance before and after high-temperature storage: After formation and capacity grading, before and after storage for 14 days at 60° C., the lithium iron phosphate battery was charged at a constant current of 1 C and a constant voltage to 3.65 V at room temperature. After resting for 5 min, the battery was discharged at a constant current of 1 C for 30 min, rested for 1 h, and then discharged at a constant current of 2 C for 10 s. And DCIR at 50% SOC was calculated.

After formation and capacity grading, before and after storage for 14 days at 60° C., the ternary battery was charged at a constant current of 1 C and a constant voltage to 4.2 V at room temperature. After resting for 5 min, the battery was discharged at a constant current of 1 C for 30 min, rested for 1 h, and then discharged at a constant current of 2 C for 10 s. DCIR at 50% SOC was calculated.

Low-temperature cycle performance: After formation and capacity grading, the lithium iron phosphate battery was discharged at a constant current of 0.5 C to 2 V at −10° C., rested for 5 min, and then charged at a constant current of 0.2 C and a constant voltage to 3.65 V for cycle test.

After formation and capacity grading, the ternary battery was discharged at a constant current of 0.5 C to 3 V at −10° C., rested for 5 min, and then charged at a constant current of 0.2 C and a constant voltage to 4.2 V for cycle test.

Room-temperature cycle performance: After formation and capacity grading, the lithium iron phosphate battery was discharged at a constant current of 1 C to 2 V at 25° C., rested for 5 min, and then charged at a constant current of 1 C and constant voltage to 3.65 V for cycle test.

After formation and capacity grading, the ternary battery was discharged at a constant current of 1 C to 3 V at 25° C., rested for 5 min, and then charged at a constant current of 1 C and constant voltage to 4.2 V for cycle test.

High-temperature cycle performance: After formation and capacity grading, the lithium iron phosphate battery was discharged at a constant current of 1 C to 2 V at 55° C., rested for 5 min, and then charged at a constant current of 1 C and a constant voltage to 3.65 V for cycle test.

After formation and capacity grading, the ternary battery was discharged at a constant current of 1 C to 3 V at 45° C., rested for 5 min, and then charged at a constant current of 1 C and a constant voltage to 4.2 V for cycle test.

Test results can be referenced in Table 1 below.

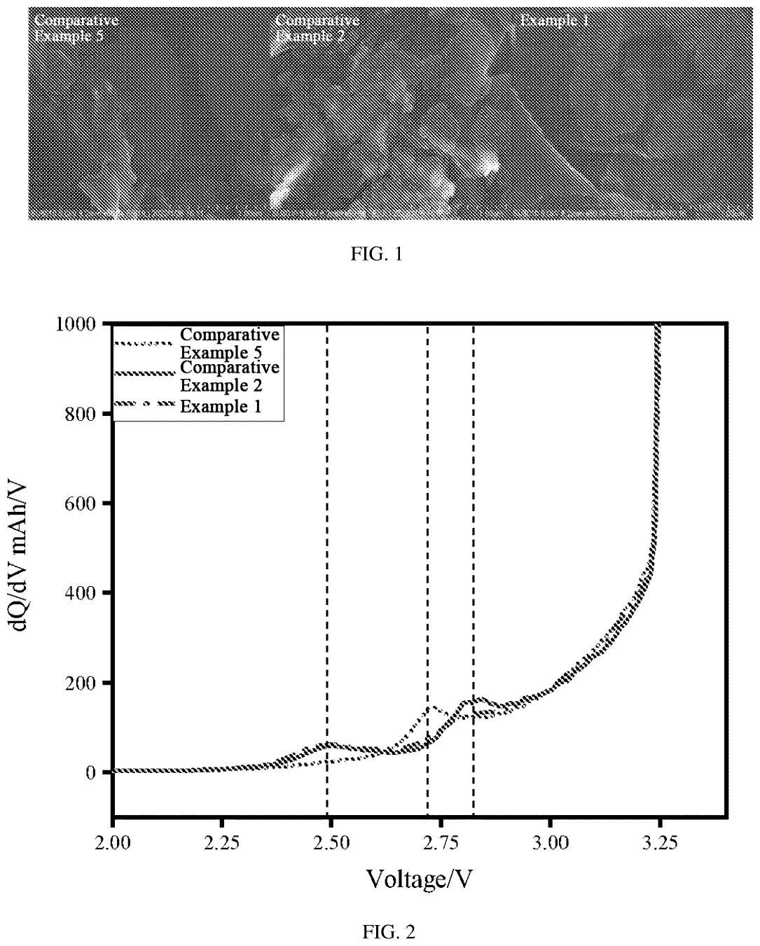

Referring to FIG. 1, FIG. 1 shows the SEM images of the battery negative electrodes of Comparative Example 5, Comparative Example 2, and Example 1.

As seen in FIG. 1, the SEI film without sulfur element formed by vinylene carbonate alone appears relatively smooth, the sulfur-rich SEI film formed by the first additive alone is relatively rough, while the SEI film formed after adding both additives is not only sulfur-rich but also appears smooth overall.

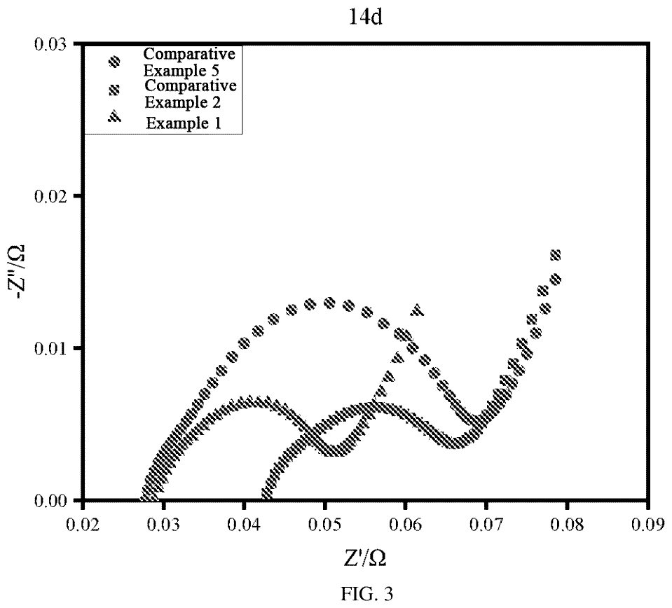

Referring to FIG. 2, FIG. 2 shows the dQ/dV curves of Comparative Example 5, Comparative Example 2, and Example 1.

As seen in FIG. 2, the first additive is preferentially reduced at around 2.5 V, which is earlier than 2.7 V of VC, while a second reduction peak appears at around 2.8 V. The second reduction peak and its product may be the primary source of gas production. In Example 1, after adding both additives, the reduction peak at around 2.5 V still exists, while the reduction peak at around 2.8 V is suppressed.

Referring to FIG. 3, FIG. 3 shows the AC impedance spectra after high-temperature storage for 14 days of Comparative Example 5, Comparative Example 2, and Example 1.

As seen in FIG. 3, when the first additive is used alone in the lithium iron phosphate battery system, RCT/RSEI impedance (charge transfer impedance or SEI film impedance, corresponding to the semicircle) of the battery is significantly reduced. However, without the addition of VC, gas production at high temperature increases Rb (internal impedance of the battery, corresponding to the X-axis intercept) of the battery. The combined use of the first additive and VC not only prevents an increase in Rb of the battery but also significantly reduces RCT/RSEI impedance of the battery, exhibiting excellent impedance reduction effects.

TABLE 1
Test results of battery performance

| | | | Number of cycles | Capacity |
|---|---|---|---|---|
| | | | with 80% capacity | retention |
| | | | retention rate | rate after |
| | Solvents and | Additives and amounts in | when cycling | 1500 cycles |
| | lithium salts | the electrolyte | at −10° C. | at 25° C./% |
| Example 1 | EC:EMC = 1:2; 13% LiPF6 | 2.5% VC + 0.1% Compound 2 | 208 | 92.7 |
| Example 2 | EC:EMC = 1:2; 13% LiPF6 | 2.5% VC + 1% Compound 2 | 301 | 93.6 |
| Example 3 | EC:EMC = 1:2; 13% LiPF6 | 2.5% VC + 5% Compound 2 | 345 | 93.3 |
| Example 4 | EC:EMC = 1:2; 13% LiPF6 | 0.1% VC + 1% Compound 2 | 312 | 83.2 |
| Example 5 | EC:EMC = 1:2; 13% LiPF6 | 1% VC + 1% Compound 2 | 308 | 89.9 |
| Example 6 | EC:EMC = 1:2; 13% LiPF6 | 5% VC + 1% Compound 2 | 251 | 93.2 |
| Example 7 | EC:EMC = 1:2; 13% LiPF6 | 2.5% VC + 1% Compound 6 | 289 | 93.1 |
| Example 8 | EC:EMC = 1:2; 13% LiPF6 | 2.5% VC + 1% Compound 1 | 293 | 93.4 |
| Example 9 | EC:EMC = 1:2; 12% | 2.5% VC + 0.1% Compound 2 | 231 | 93 |
| | LiPF6 + 1% LiFSI | | | |
| Example 10 | EC:EMC:DEC = 3:5:2; 13% | 2.5% VC + 0.1% Compound 2 | 210 | 92.6 |
| | LiPF6 | | | |
| Example 11 | EC:EMC = 1:2; 13% LiPF6 | 2.5% VC + 0.1% Compound 2 + 1% FEC | 225 | 93 |
| Example 12 | EC:EMC = 1:2; 13% LiPF6 | 2.5% VC + 0.1% Compound 2 + 0.5% TMSP | 262 | 93.5 |
| Comparotive | EC:EMC = 1:2; 13% LiPF6 | / | 45 | 63.3 |
| Example 1 | | | | |
| Comparative | EC:EMC = 1:2; 13% LiPF6 | 0.1% Compound 2 | 220 | 46.7 |
| Example 2 | | | | |
| Comparative | EC:EMC = 1:2; 13% LiPF6 | 1% Compound 2 | 330 | 25.1 |
| Example 3 | | | | |
| Comparative | EC:EMC = 1:2; 13% LiPF6 | 1% VC | 38 | 88.6 |
| Example 4 | | | | |
| Comparative | EC:EMC = 1:2; 13% LiPF6 | 2.5% VC | 35 | 90.7 |
| Example 5 | | | | |
| Comparative | EC:EMC = 1:2; 13% LiPF6 | 5% VC | 28 | 88.9 |
| Example 6 | | | | |
| Compararive | EC:EMC = 1:2; 13% LiPF6 | 2.5% VEC + 0.1% Compound 2 | 112 | 88.1 |
| Example 7 | | | | |
| Comparative | EC:EMC = 1:2; 13% LiPF6 | 2.5% VC + 0.1% Compound I | 26 | 90.6 |
| Example 8 | | | | |
| Comparative | EC:EMC = 1:2; 13% LiPF6 | 2.5% VC + 0.5% lithium difluorophosphate | 44 | 91 |
| Example 9 | | | | |
| Comparative | EC:EMC = 1:2; 13% LiPF6 | 2.5% VC + 1% phenyl methanesulfonate | 43 | 90.9 |
| Example 10 | | | | |
| Comparative | EC:EMC = 1:2; 13% LiPF6 | 2.5% VC + 1% Compound II | 44 | 90.8 |
| Example 11 | | | | |
| Comparative | EC:EMC = 1:2; 13% LiPF6 | 2.5% VC + 1% Compound III | 33 | 90.6 |
| Example 12 | | | | |
| Comparative | EC:EMC = 1:2; 13% LiPF6 | 2.5% prop-1-ene-1,3-sultone + 0.1% Compound 2 | 175 | 43.2 |
| Example 13 | | | | |
| Comparative | EC:EMC = 1:2; 13% LiPF6 | / | 280 | 88.2 |
| Example 14 | | | | |
| Comparative | EC:EMC = 1:2; 13% LiPF6 | 2.5% VC + 0.1% Compound II | 294 | 89.3 |
| Example 15 | | | | |
| Comparative | EC:EMC = 1:2; 13% LiPF6 | 2.5% VC | 271 | 87.8 |
| Example 16 | | | | |

| | | | | Thickness | | |
|---|---|---|---|---|---|---|
| | | | | expansion | | |
| | Capacity | Capacity | Capacity | rate by thermal | | |
| | retention | retention rate | recovery rate | measurement | DCIR | DCR |
| | rate after | after high- | after high- | after high- | before high- | after high- |
| | 1500 cycles. | temperature | temperature | temperature | temperature | temperature |
| | at 55° C. | storage | storage | storage | storage | storage |
| | (45° C.)/% | for 14 d/% | for 14 d/% | for 14 d/% | [symbol] /mΩ | for 14 d/mΩ |
| Example 1 | 88 | 94.5 | 96.1 | 1 | 67.2 | 71 |
| Example 2 | 89.2 | 95.3 | 97.2 | 1 | 66.5 | 68.9 |
| Example 3 | 88.5 | 95 | 97.1 | 1 | 65.6 | 69.2 |
| Example 4 | 78.3 | 93.6 | 95.8 | 3 | 64.3 | 66.3 |
| Example 5 | 85.3 | 93.9 | 95 | 1 | 65.6 | 67.7 |
| Example 6 | 88.1 | 94.9 | 96.8 | 1 | 68.8 | 70.1 |
| Example 7 | 88.7 | 95 | 96.9 | 1 | 66.9 | 69.3 |
| Example 8 | 88.5 | 94.9 | 96.8 | 1 | 67 | 69.6 |
| Example 9 | 88.4 | 94.6 | 96.2 | 1 | 67 | 69.6 |
| Example 10 | 88.1 | 94.5 | 96.2 | 1 | 67.3 | 71.3 |
| Example 11 | 88.5 | 94.7 | 96.7 | 3 | 66.8 | 70.5 |
| Example 12 | 89 | 95.1 | 97.2 | 1 | 66.7 | 70 |
| Comparotive | 57.9 | 91.2 | 93.1 | 1 | 69.5 | 78.1 |
| Example 1 | | | | | | |
| Comparative | 32.5 | 51 | 73 | 51 | 64.5 | 90.7 |
| Example 2 | | | | | | |
| Comparative | 18.9 | 42 | 61 | 73 | 63.8 | 93 |
| Example 3 | | | | | | |
| Comparative | 84.1 | 92.2 | 93.4 | 1 | 71.2 | 78.9 |
| Example 4 | | | | | | |
| Comparative | 86.8 | 93 | 95 | 1 | 72 | 80.1 |
| Example 5 | | | | | | |
| Comparative | 85.2 | 92 | 94.2 | 1 | 74.9 | 83 |
| Example 6 | | | | | | |
| Compararive | 84.3 | 63 | 78 | 47 | 68.3 | 91.6 |
| Example 7 | | | | | | |
| Comparative | 87.1 | 93.2 | 95.3 | 1 | 72.8 | 82.3 |
| Example 8 | | | | | | |
| Comparative | 87.3 | 93.5 | 95.5 | 1 | 71.4 | 81.3 |
| Example 9 | | | | | | |
| Comparative | 86.6 | 93.2 | 95.2 | 1 | 71.5 | 79.5 |
| Example 10 | | | | | | |
| Comparative | 87 | 93.2 | 95.3 | 1 | 70.5 | 78.7 |
| Example 11 | | | | | | |
| Comparative | 86.9 | 93 | 94.9 | 1 | 71.5 | 79.6 |
| Example 12 | | | | | | |
| Comparative | 30.1 | 62.3 | 79.5 | 47.3 | 70.4 | 93.5 |
| Example 13 | | | | | | |
| Comparative | 75.3 | 89 | 94 | 6 | 54.4 | 57.5 |
| Example 14 | | | | | | |
| Comparative | 76.2 | 90.2 | 95.3 | 3 | 53.4 | 56.2 |
| Example 15 | | | | | | |
| Comparative | 74.9 | 88.5 | 95.1 | 4.3 | 55.3 | 57.9 |
| Example 16 | | | | | | |

[symbol]

indicates data missing or illegible when filed

Referring to Table 1, at least the following conclusions can be drawn:
1. Referring to Example 1, Comparative Example 1, Comparative Example 2, and Comparative Example 5, it can be found that:

Regarding the capacity retention rate after 1500 cycles at 25° C., and capacity retention rate after 1500 cycles at 55° C. (45° C.), VC plays a primary role.

Regarding the DCIR change rate, Example 1 increased by 3.8 mΩ, Comparative Example 1 increased by 8.6 mΩ, and Comparative Example 5 increased by 7.9 mΩ; which indicates that the first additive in the present application plays a dominant role in improving DCIR in synergy with VC.

It is worth noting that when using VC alone, the performance significantly deteriorates regarding number of cycles with 80% capacity retention rate when cycling at −10° C., suggesting that the first additive plays a dominant role in improving low-temperature cycle.
2. Referring to Example 1, Comparative Example 1, Comparative Example 2, Comparative Example 5, Comparative Example 14, Comparative Example 15, and Comparative Example 16, it can be found that:

In the ternary system, the improvements in the capacity retention rate after 1500 cycles at 25° C., capacity retention rate after 1500 cycles at 55° C. (45° C.), and DCIR change rate are not particularly significant, indicating a relatively balanced improvement effect. VC at an adding amount of 2.5% has a slightly negative effect on the ternary battery, suggesting that the amount of VC added to the ternary battery system should not be excessive.

The ternary system also does not exhibit a significant advantage regarding the number of cycles with 80% capacity retention rate when cycling at −10° C.

It can be concluded that: in the lithium iron phosphate system, the combination of the first additive and VC has a significant advantage in improving low-temperature cycle and DCIR change rate.
3. Referring to Comparative Example 2, Comparative Example 3, Example 1, and Example 2, it can be found that in the absence of VC, increasing the amount of the first additive leads to a deterioration in the capacity retention rate after 1500 cycles at 25° C. and capacity retention rate after 1500 cycles at 55° C. (45° C.), which suggests that the first additive has a negative effect on the capacity retention rate after 1500 cycles at 25° C. and capacity retention rate after 1500 cycles at 55° C. (45° C.).

Similarly, referring to Comparative Examples 4-6, it can be found that in the absence of the first additive, VC also has a negative effect on the number of cycles with 80% capacity retention rate when cycling at −10° C.
4. Through the comparison of Example 1, Comparative Example 1, Comparative Example 2, Comparative Example 7, and Comparative Example 13, it can be found that compared to VC, VEC and prop-1-ene-1,3-sultone have a more negative effect on the number of cycles with 80% capacity retention rate when cycling at −10° C., which suggests that while using VC alone has a significant negative effect on this performance, when combined with the first additive, this negative effect can be substantially eliminated. Therefore, regarding the number of cycles with 80% capacity retention rate when cycling at −10° C., the combination of the first additive and VC proves to be highly effective.
5. Through the comparison of Example 1 and Comparative Example 8, it can be found that while Compound I has a structure similar to Compound 2 of the present application, it has no effect on the number of cycles with 80% capacity retention rate when cycling at −10° C.;
through the comparison of Example 2 and Comparative Examples 11 and 12, it can be found that while Compounds II and III have many identical technical features with Compound 2, they have no effect on the number of cycles with 80% capacity retention rate when cycling at −10° C.;
through the above analysis, it can be found that not all the compounds described in 202111199078.7 are suitable for use in the lithium iron phosphate system. In other words, only the combinations of the compounds of the present application and VC are suitable for the lithium iron phosphate system.
6. Through the comparison of Example 2 and Comparative Examples 9 and 10, it can be found that the combined use of conventional low-temperature additive or film forming additive with VC does not improve the performance in the number of cycles with 80% capacity retention rate when cycling at −10° C. in the present application.

### Review

The above Examples and Comparative Examples demonstrate the following conclusions:

Conclusion 1: VC plays a dominant role in improving the capacity retention rate after 1500 cycles at 25° C. and capacity retention rate after 1500 cycles at 55° C. (45° C.); whereas the first additive plays a detrimental role.

Conclusion 2: The first additive plays a dominant role in improving the number of cycles with 80% capacity retention rate when cycling at −10° C.; whereas VC plays a detrimental role.

Conclusion 3: The combined use of the first additive and VC synergistically improves the DCIR change rate.

Conclusion 4: Regarding the capacity retention rate after 1500 cycles at 25° C. and capacity retention rate after 1500 cycles at 55° C. (45° C.), VC can eliminate the negative effect of the first additive, while other similar additives can not eliminate the negative effect of the first additive;
regarding the number of cycles with 80% capacity retention rate when cycling at −10° C., the first additive can eliminate the negative effect of VC, while other similar additives can not eliminate the negative effect of VC.

These conclusions confirm that: regarding the capacity retention rate after 1500 cycles at 25° C., capacity retention rate after 1500 cycles at 55° C. (45° C.), number of cycles with 80% capacity retention rate when cycling at −10° C., and DCIR change rate, the combined use of the first additive and VC represents the only optimal choice.

The technical features described in the aforementioned examples can be combined arbitrarily. For brevity, not all possible combinations of these technical features are described. However, any combination of these features, as long as they do not contradict each other, should be considered within the scope of this description.

The aforementioned examples only describe a few embodiments of the present application, while the descriptions are specific and detailed, they should not be interpreted as limiting the scope of the present application. It should be noted that the ordinary skills in the art can make various modifications and improvements without departing from the concept of the present application, which are all within the protection scope of the present application. Therefore, the protection scope of the present application should be determined based on the appended claims.

1. An electrolytic solution for a lithium iron phosphate battery, comprising a solvent, a lithium salt, a first additive and a second additive, the first additive has a general structural formula of Formula (I); 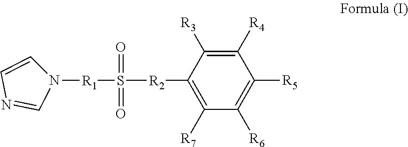
wherein R₁ and R₂ are each independently selected from the group consisting of O, CH₂, and a carbon-carbon single bond, and at least one of R₁ and R₂ is O;
R₃, R₄, R₅, R₆, and R₇ are each independently selected from the group consisting of H, halogen, C₁₋₈ alkyl, C₂₋₈ alkenyl, C₃₋₈ alkynyl, halogen-substituted C₁₋₈ alkyl, halogen-substituted C₂₋₈ alkenyl, and halogen-substituted C₃₋₈ alkynyl; and
the second additive is vinylene carbonate.

2. The electrolytic solution for the lithium iron phosphate battery according to claim 1, wherein R₁ and R₂ are each independently selected from the group consisting of O and a carbon-carbon single bond; and
R₃, R₄, R₅, R₆, and R₇ are each independently selected from the group consisting of H, F, C₁₋₆ alkyl, C₂₋₆ alkenyl, C₃₋₈ alkynyl, F-substituted C₁₋₆ alkyl, F-substituted C₂₋₆ alkenyl, and F-substituted C₃₋₆ alkynyl.

3. The electrolytic solution for the lithium iron phosphate battery according to claim 2, wherein R₂ is O; and R₃, R₄, R₅, R₆, and R₇ are each independently selected from the group consisting of H, F, methyl, ethyl, 1-propyl, 2-propyl, 1-butyl, 2-methyl-1-propyl, 2-butyl, fluoromethyl, fluoroethyl, fluoro-1-propyl, fluoro-2-propyl, fluoro-1-butyl, fluoro-2-methyl-1-propyl, fluoro-2-butyl, vinyl, propenyl, butenyl, fluorovinyl, fluoropropenyl, fluorobutenyl, propynyl, butynyl, fluoropropynyl, and fluorobutynyl.

4. The electrolytic solution for the lithium iron phosphate battery according to claim 1, wherein the first additive is selected from the group consisting of the following compounds:

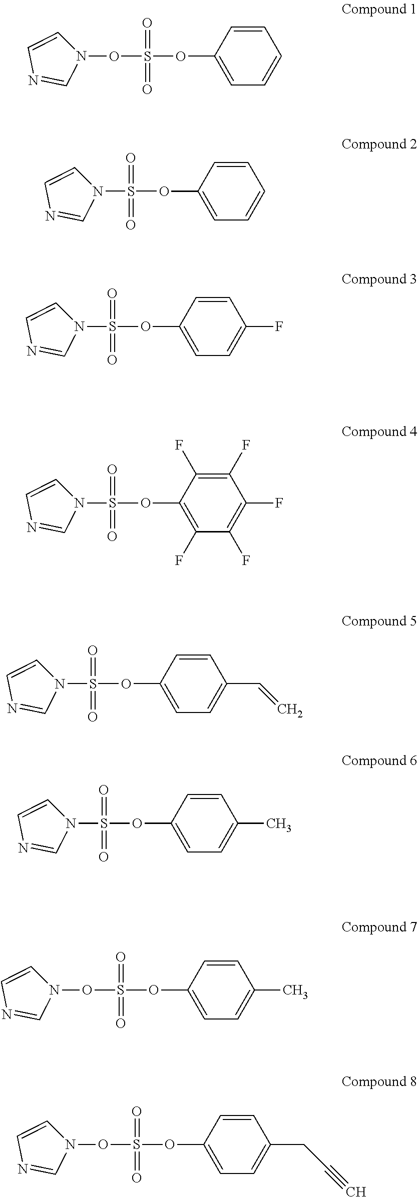

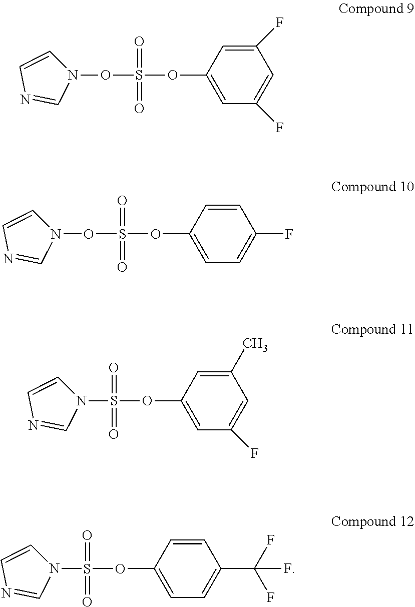 [SMILES: O=S(=O)(Oc1cc(F)cc(F)c1)On1ccnc1 ; O=S(=O)(Oc1ccc(F)cc1)On1ccnc1 ; Cc1cc(F)cc(OS(=O)(=O)n2ccnc2)c1 ; O=S(=O)(Oc1ccc(C(F)(F)F)cc1)n1ccnc1]

5. The electrolytic solution for the lithium iron phosphate battery according to claim 1, wherein an adding amount of the first additive accounts for 0.01%-10% of a total mass of the electrolytic solution; and an adding amount of the second additive accounts for 0.1%-5% of the total mass of the electrolytic solution.

6. The electrolytic solution for the lithium iron phosphate battery according to claim 5, wherein the adding amount of the first additive accounts for 0.1%-5% of the total mass of the electrolytic solution; and the adding amount of the second additive accounts for 1%-5% of the total mass of the electrolytic solution.

7. The electrolytic solution for the lithium iron phosphate battery according to claim 1, wherein the lithium salt is selected from the group consisting of lithium hexafluorophosphate, lithium tetrafluoroborate, lithium bis(oxalato)borate, lithium difluoro(oxalato)borate, lithium difluoro(oxalato)phosphate, lithium tetrafluoro(oxalato)phosphate, lithium bis(fluorosulfonyl)imide, lithium bis(trifluoromethanesulfonyl)imide, and a combination thereof, and a mass fraction of the lithium salt in the electrolytic solution is 5%-20%.

8. The electrolytic solution for the lithium iron phosphate battery according to claim 7, wherein the mass fraction of the lithium salt in the electrolytic solution is 7%-18%.

9. The electrolytic solution for the lithium iron phosphate battery according to claim 7, wherein the mass fraction of the lithium salt in the electrolytic solution is 10%-15%.

10. The electrolytic solution for the lithium iron phosphate battery according to claim 1, wherein the lithium salt is selected from the group consisting of lithium difluorophosphate, lithium monofluorophosphate, and a combination thereof, and a mass fraction of the lithium salt in the electrolytic solution is 0.01%-1%.

11. The electrolytic solution for the lithium iron phosphate battery according to claim 1, wherein the lithium salt is selected from the group consisting of lithium difluorophosphate, lithium monofluorophosphate, and a combination thereof, and a mass fraction of the lithium salt in the electrolytic solution is 0.02%-1%.

12. The electrolytic solution for the lithium iron phosphate battery according to claim 1, wherein the solvent comprises a cyclic solvent and/or a linear solvent;
the cyclic solvent is selected from the group consisting of ethylene carbonate, propylene carbonate, γ-butyrolactone, phenyl acetate, 1,4-butane sultone, 3,3,3-trifluoropropylene carbonate, and a combination thereof;
the linear solvent is selected from the group consisting of dimethyl carbonate, ethyl methyl carbonate, diethyl carbonate, methyl propyl carbonate, methyl formate, ethyl acetate, methyl acetate, propyl acetate, butyl acetate, methyl propionate, ethyl propionate, propyl propionate, butyl propionate, methyl butyrate, ethyl butyrate, ethylene glycol dimethyl ether, 1,1,2,2-tetrafluoroethyl-2,2,3,3-tetrafluoropropyl ether, methyl 2,2,2-trifluoroethyl carbonate, bis(2,2,2-trifluoroethyl)carbonate, 2,2-difluoroethyl acetate, 2,2-difluoroethyl propionate, methyl 2,2-difluoroethyl carbonate, and a combination thereof, and
in the electrolytic solution, a content of the solvent is 65%-94.89% by mass percentage.

13. The electrolytic solution for the lithium iron phosphate battery according to claim 1, wherein, in the electrolytic solution, a content of the solvent is 70%-85% by mass percentage.

14. The electrolytic solution for the lithium iron phosphate battery according to claim 1, wherein, in the electrolytic solution, a content of the solvent is 75%-85% by mass percentage.

15. The electrolytic solution for the lithium iron phosphate battery according to claim 1, wherein the electrolytic solution further comprises a third additive, the third additive is selected from the group consisting of a sulfur-containing additive, a phosphorus-containing additive, a nitrogen-containing additive, an ester additive, and a combination thereof;
the sulfur-containing additive is selected from the group consisting of ethylene sulfate, 1,3-propanesultone, methylene methanedisulfonate, prop-1-ene-1,3-sultone, N-phenylbis(trifluoromethanesulfonyl)imide, 2,4,8, 10-tetraoxa-3,9-dithiaspiro[5.5]undecane 3,3,9,9-tetraoxide, and a combination thereof;
the phosphorus-containing additive is selected from the group consisting of tris(trimethylsilyl) phosphate, tris[ethenyl(dimethyl)silyl] phosphate, tetramethyl methylenediphosphonate, and a combination thereof;
the nitrogen-containing additive is selected from the group consisting of prop-2-yn-1-yl 1H-imidazole-1-carboxylate, hexamethylene diisocyanate, prop-2-en-1-yl 1H-imidazole-1-carboxylate, 2-fluoropyridine, and a combination thereof;
the ester additive is selected from the group consisting of vinyl ethylene carbonate, fluoroethylene carbonate, ethenyl 2,2,2-trifluoroethyl carbonate, and a combination thereof; and
an amount of the third additive is no more than 5% of a total amount of the electrolytic solution.

16. A lithium iron phosphate battery, comprising:
a positive electrode plate;
a negative electrode plate;
a separator; and
the electrolytic solution for the lithium iron phosphate battery according to claim 1;
wherein an active substance of the positive electrode plate is lithium iron phosphate.
